(19) United States
(12) Patent Application Publication
(10) Pub. No.: US 2004/0251231 A1
(43) Pub. Date: Dec. 16, 2004

(54) Circuit board and manufacturing method of the same

(76) Inventors: Motoki Takahira, Kariya-city (JP); Yoshiteru Ootsuki, Nagoya-city (JP)

Correspondence Address: HARNESS, DICKEY & PIERCE, P.L.C., P.O. BOX 828, BLOOMFIELD HILLS, MI, 48303, US

(21) Appl. No.: 10/798,969

(22) Filed: Mar. 11, 2004

(30) Foreign Application Priority Data
Mar. 12, 2003 (JP) 2003-66369

(51) Int. Cl. H01B 13/00

(52) U.S. Cl. 216/13

(57) ABSTRACT

A circuit board is comprised of a metal plate, a printed circuit, and an electronic component. The metal plate serves as a base. The printed circuit is placed on one side of the metal plate. The electronic component is placed on the other side of the metal plate. The metal plate has an opening which reaches the printed circuit at the bottom of the metal plate. An insulating piece is inserted in the opening. The insulating piece has about the same thickness as the metal plate. A through-hole is made through both of the insulating piece and the printed circuit. A lead wire of the electronic component is extended through the through-hole and connected to the circuit pattern of the printed circuit by a conductive metal.

### CROSS REFERENCE TO RELATED APPLICATION

This application is based on Japanese Patent Application No.2003-66369(filed on Mar. 12, 2003), the disclosure of which is incorporated herein by reference.

### BACKGROUND OF THE INVENTION

1. Field of the Invention

The present invention relates to a circuit board which is comprised of a metal plate as a base, a printed circuit board layered on one side of the metal plate, and electronic components with lead wires connected through the metal plate to circuit patterns by soldering or the like.

2. Description of Related Art

A circuit board with a metal plate as a base and a printed circuit layered on one side of the metal plate is proposed, for example, in Japanese Patent Application Laid-open Publication No. H8-288647.

This type of circuit board which is comprised of a metal plate and a printed circuit has, on occasion, electronic components mounted on the surface of the metal plate for the ease of heat release. In that case, lead wires of the electronic components are extended through the metal plate and soldered to the circuit pattern. This structure necessitates the insulation of lead wires from the metal plate.

FIG. 6 illustrates the pattern cross section of lead insulation structure, which is similar to that disclosed in Japanese Patent Application Laid-open Publication No. H8-288647.

In a circuit board 100 shown in FIG. 6, a printed circuit 2 that is comprised of a thermosetting resin film 2a and a metal foil circuit pattern 2b is stuck to one side of the metal plate 1 as a base by using an adhesive layer 3. On the other side of the metal plate 1, an electronic component 50 is mounted.

The circuit board 100 in FIG. 6 has the metal plate 1, the adhesive layer 3 and a through-hole 4 on the printed circuit 2. A lead wire 5 of the electronic component 50 is insulated by a rubber-like bushing 6 and inserted forcibly into the through-hole 4. This ensures the insulation between the lead wire 5 and the metal plate 1. Also, the end of the lead wire 5 stuck from the surface of the printed circuit 2 is connected to the circuit pattern 2b by using a conductive metal like soldering 7, and this completes a circuit with the electronic component 50.

In the insulation structure of the circuit board 100 shown in FIG. 6, each lead wire 5 needs to have its own insulation bushing 6. Consequently, if the electronic component 50 has many lead wires 5, such as a connector, connection work increases accordingly and that leads to higher production cost. Also, if lead insulation structure in FIG. 6 is adopted, the insulation bushing 6 is forced into the through-hole 4 to avoid the overflow of soldering 7 and that results in the concentration of heat-dilation stress in the connecting part of lead wire 5 and the circuit pattern 2b, and easily leads to breakups in the proximity of the connecting part.

### SUMMARY OF THE INVENTION

In view of the foregoing problems, it is an object of the present invention to provide a manufacturing method of an inexpensive circuit board by assuring the insulation of lead wire of electronic components from a metal plate, and thus suppressing breakups in the proximity of the connecting part of a circuit pattern and a lead wire.

The circuit board according to this invention is comprised of a metal plate, a printed circuit, and electronic components. The metal plate serves as a base. The printed circuit is attached to one side of the metal plate and forms a circuit board. The electronic components are mounted on the other side of the metal plate. The metal plate has an opening that is backed by the printed circuit. An insulating piece of similar thickness is inserted into the opening. The insulating piece has the first through-hole, and the printed circuit has the second through-hole. Lead wires of the electronic components are placed through both of the first and the second through-holes, and connected to the circuit pattern of the printed circuit by using a conductive metal.

The lead wires of the mounted electronic components are, in the case of the above circuit board, placed in the through-hole formed on the insulating piece that is inserted in the opening of the metal plate. This leads to the assurance of insulation when a proper distance is set between the through-hole and the periphery. Also, as the insulating piece secures the distance between the lead wire and the metal plate, overflow of the conductive metal can be tolerated when lead wires are connected to the circuit pattern by a process like soldering of the conductive metal. Consequently, between the insulation board and the metal plate, the insulation board and the lead wire, or in the direction of thickness in the opening of the metal plate, a clearance can be set. For this reason, stress from the insulating piece heat-dilation in the connecting part can be released, and breakups in the proximity of the connecting part of the lead wire and the circuit pattern are suppressed.

### BRIEF DESCRIPTION OF THE DRAWINGS

Additional objects and advantages of the present invention will be more readily apparent from the following detailed description of preferred embodiments when taken together with the accompanying drawings, in which:

FIG. 1A is a schematic cross sectional view of a circuit board showing an insulation structure of a lead wire according to a first embodiment of the present invention, and FIG. 1B is a perspective view of the circuit board with its component expanded in the process of manufacturing.

FIG. 2 is a cross sectional view of a circuit board with an electronic component of plural lead wires on board according to the first embodiment of the invention.

FIG. 3A to 3E and FIG. 4A to 4C are cross sectional views of steps of manufacturing process of the circuit board according to the first embodiment.

FIG. 5A is a schematic cross sectional view of insulation structure of lead wires connected to the circuit board according to the second embodiment of this invention, and FIG. 5B is a perspective view of a circuit board with its component expanded in the process of manufacturing.

FIG. 6 is a schematic cross sectional view of a lead wire insulation structure of a circuit board according to a prior art.

### DETAILED DESCRIPTION OF THE PRESENTLY PREFERRED EMBODIMENTS

(First Embodiment)

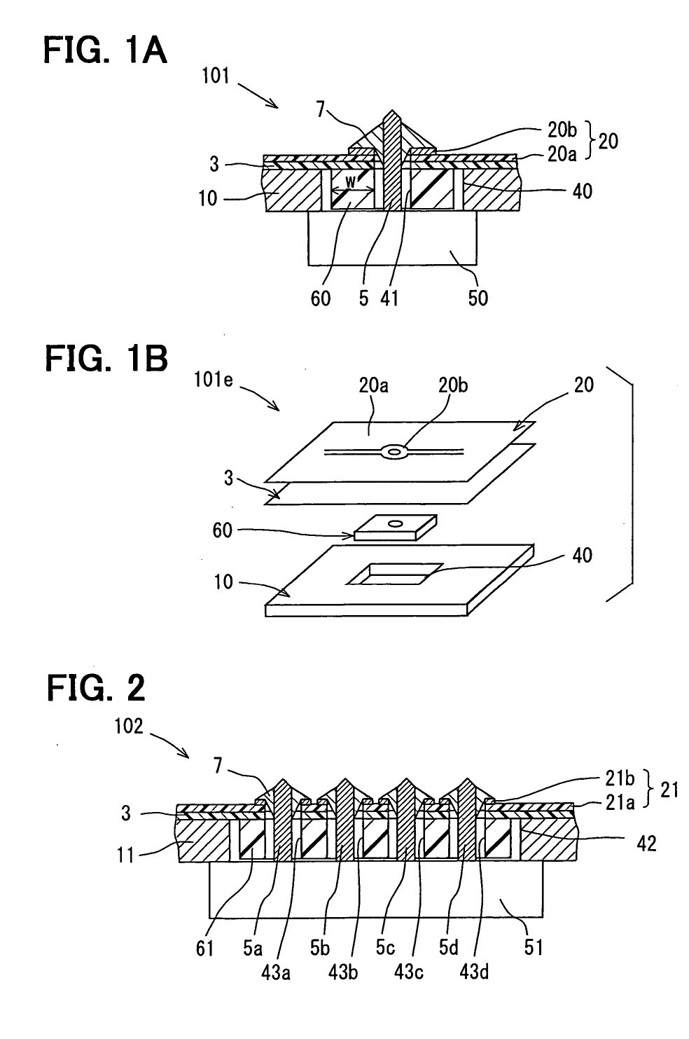

In a circuit board 101 shown in FIG. 1A, a printed circuit 20 is used. This circuit 20 is comprised of a thermosetting resin film 20a and a circuit pattern of metal foil 20b formed on the resin film 20a. The thermosetting resin film 20a is made of, for example, polyimide film. The metal foil of the circuit pattern 20b is made of, for example, copper. The printed circuit 20 is stuck on one side of a base metal plate 10 with an adhesive layer 3 which is placed on the other side of the circuit pattern 20b. The base metal plate 10 is made of aluminum. The base metal plate 10 may be made of copper. The electronic component 50 is mounted on the other side of the metal plate 10.

The metal plate 10 has an opening 40 with the printed circuit 20 as its bottom part, and an insulating piece 60 of similar thickness is inserted. The insulating piece 60 is made of heat-resistant thermosetting resin. The insulating piece 60 may also be made of heat-resistant rubber or ceramics. The printed circuit 20 at the bottom of the opening 40 has a through-hole 41 that passes through both the insulating piece 60 and the printed circuit 20.

On the circuit board 101 shown in FIG. 1A, a lead wire 5 of the electronic component 50 mounted on the metal plate 10 is placed in the through-hole 41 of the insulating piece 60 that is inserted in the opening 40 of the metal plate 10. This ensures the insulation of lead wire 5 from metal plate 10 when a proper distance w from the through-hole 41 of the insulating piece 60 to the periphery shown in FIG. 1A is set.

The through-hole 41 can easily be formed collectively at the same time when the printed circuit 20 and the insulating piece 60 are being layered. This also reduces a hole aligning step. The through-hole 41 can also be made separately from the printed circuit 20 and from the insulating piece 60.

In FIG. 1A, the end of lead wire 5 that runs out from the surface of the printed circuit 20 is connected to the circuit pattern 20b by using the conductive metal 7, and this connection completes an electronic circuit including the electronic components 50. On the circuit board 101 shown in FIG. 1A, as the insulating piece 60 ensures the distance between the lead wire 5 and the metal plate 10, overflow of the conductive metal 7 can be controlled when the lead wire 5 is connected to the circuit pattern 20b by the conductive metal 7 like soldering. Consequently, a clearance can be set as shown in FIG. 1A between the insulating piece 60 and the metal plate 10, between the insulating piece 60 and the lead wire 5, or in the direction of the thickness of the metal plate 10 at the opening 40. Consequently, breakups in the proximity of connecting part of the lead wire 5 and the circuit pattern 20b are suppressed, because stress from heat-dilated insulating piece 60 in the proximity of the connecting part of the lead wire 5 and circuit pattern 20b can be released. Also, as the insulating piece 60 inserted in the opening 40 is stuck to the printed circuit 20 by the adhesive layer 3, handling the circuit board 101 will not loosen the insulating piece 60.

In a circuit board 102 shown in FIG. 2, the printed circuit 21 which is comprised of thermosetting resin film 21a and the metal foil circuit pattern 21b is stuck to one side of a metal plate 11 by the adhesive layer 3. An electronic component 51 with four lead wires 5a to 5d is mounted on the other side of the metal plate 11.

The metal plate 11 has an opening 42 which has the printed circuit 21 as its bottom, and the opening 42 has an insulating piece 61 of similar thickness inserted in it. The insulating piece 61 and the printed circuit 21 at the bottom of the opening 42 have four through-holes 43a to 43d therein in correspondence with the four lead wires 5a to 5d respectively.

The ends of the lead wires 5a to 5d that run out of the surface of the printed circuit 21 are connected to the circuit pattern 21b. This completes an electronic circuit on the electronic component 51.

In the circuit board 102 shown in FIG. 2, four lead wires 5a to 5d of electronic component 51 are insulated by the insulating piece 61 from the metal plate 11. Consequently, an insulating piece need not be attached to each lead wire 5a to 5b as opposed to the circuit board 100 shown in FIG. 6. This reduces manufacturing steps of the circuit board 102 and makes it to be inexpensive.

The circuit boards 101 and 102 in FIG. 1A and FIG. 2 are suitable for automotive meter panels. An automotive meter panel uses large-sized circuit boards and carries various kinds of electronic components such as connectors with many lead wires, motors as large electronic parts and buzzers. The metal plates 10 and 11 of the circuit boards 101 and 102 can be used for releasing heat from those various electronic components. Moreover, electronic components with many lead wires are insulated securely from metal plate 10 and 11 by the insulation structure shown in FIG. 1A and FIG. 2 and breakups in the proximity of the connecting parts are also suppressed. Further, larger circuit boards for automotive meter panels can even be manufactured inexpensively by this method.

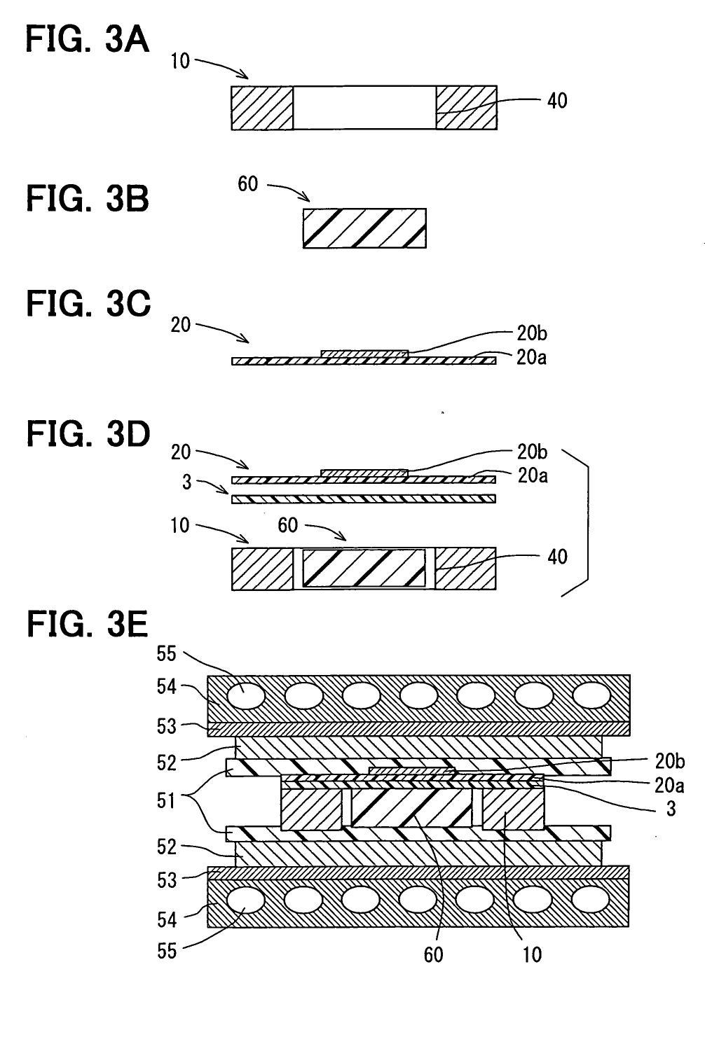

In the manufacturing method for the circuit board 101 shown in FIG. 1A, the metal plate 10 with the opening 40 is prepared in the first step as a base as shown in FIG. 3A.

Also, the insulating piece 60 with the similar thickness as the metal plate 10 and the size insertable in the opening 40 as shown in FIG. 3B is prepared.

Likewise, the printed circuit 20 with certain circuit pattern of metal foil 20b formed on thermosetting resin film 20a is prepared as shown in FIG. 3C.

Then, as shown in FIG. 3D, the insulating piece 60 is inserted into the opening 40 of the metal plate 10, and the printed circuit 20 are layered onto the metal plate 10 with its circuit pattern 20b oriented outward. An adhesive sheet 3 that is made of thermosetting resin prepreg is put between the printed circuit 20 and the metal plate 10. This adhesive sheet 3 becomes the adhesive layer 3 of the circuit board 101 in FIG. 1A.

The next step is, as shown in FIG. 3E, layered set of the metal plate 10, the insulating piece 60, the adhesive sheet 3 and the printed circuit 20, accompanied by attachment protection films 51, cushion materials 52, and metal plates 53, are put between a pair of thermo-press boards 54 with built-in heaters.

Thermo-press boards 54 apply both heat and pressure for the metal plate 10 and the insulating piece 60 to stick to the printed circuit 20 into a unit by using the adhesive sheet 3.

The attachment protection films 51 are used to protect the resin film 20a or the adhesive sheet 3 from sticking to the neighboring materials, and also to protect the resin film 20a and the circuit pattern 20b from scratches, and are made up of, for example, polyimide films. The cushion materials 52 are used to give pressure evenly to the object, and are made up of, for example, woven stainless steel fibers. The metal plates 53 are the protection for thermo-press boards 54 from scratches, and are made up of, for example, stainless (SUS) or titanium (Ti).

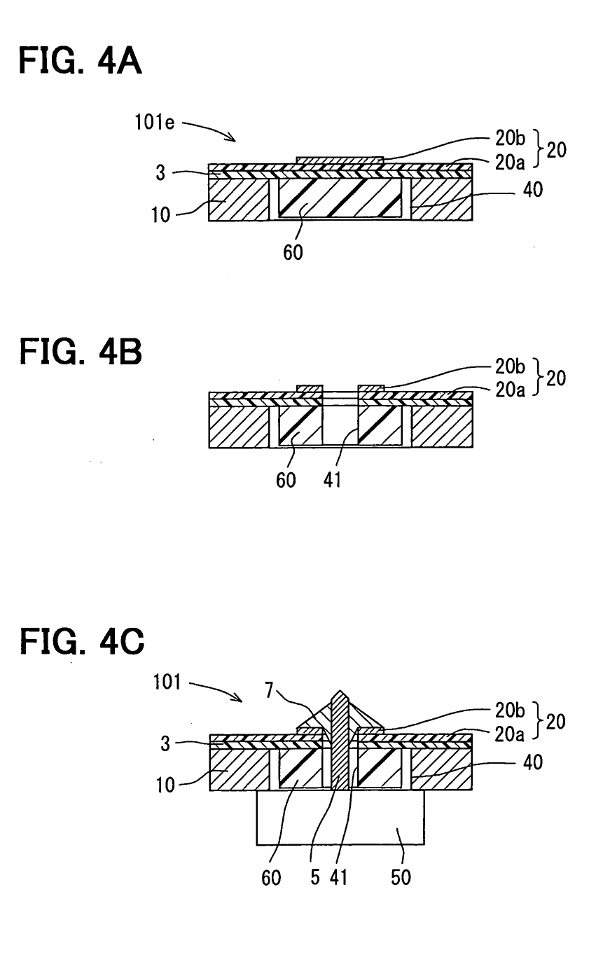

The above heat-pressurizing process makes the metal plate 10 and the insulating piece 60 with the adhesive sheet 3 stuck to the printed circuit 20 to form a circuit board 101e as shown in FIG. 4A. FIG. 1B shows the circuit board 101e in the middle of manufacturing with its components exploded in a perspective view.

The next step is to form the through-hole 41 in the attached set of the printed circuit 20 and the insulating piece 60 by, for example, a press as shown in FIG. 4B.

FIG. 4C shows the final step wherein the electronic component 50 is mounted on the other side of the printed circuit 20 on the metal plate 10 with its lead wire 5 put in the through-hole 41, and then the lead wire 5 is connected to the circuit pattern 20b on the printed circuit 20 by using the conductive metal 7.

In the manufacturing method of the circuit board 101 described above, the insulating piece 60 that insulates the lead wire 5 of the electronic component 50 from the metal plate 10 is inserted in the opening 40 on the metal plate 10 and stuck to the printed circuit 20 together with the metal plate 10 integrally. This insulating piece 60 is utilized in the latter process wherein insulation structure between the lead wire 5 and the metal plate 10 can easily be achieved by forming the through-hole 41. Adopting this manufacturing method saves the preparation process of, for example, five insulating pieces 60 corresponding to each of the five lead wires 5 of the electronic component 50 when the electronic component 50 has five lead wires. This manufacturing method also simplifies the conventional process, wherein the insulating bushing 6 is attached to each of the lead wires of the electronic component on the circuit board 100 as shown in FIG. 6. Consequently, the circuit board 101 can be manufactured inexpensively.

(Second Embodiment)

In the circuit board 101 shown in FIG. 1A, the printed circuit 20 made of the thermosetting resin film 20a is used. However, a printed circuit made of a thermoplastic resin film can also be used to manufacture a circuit board of this invention.

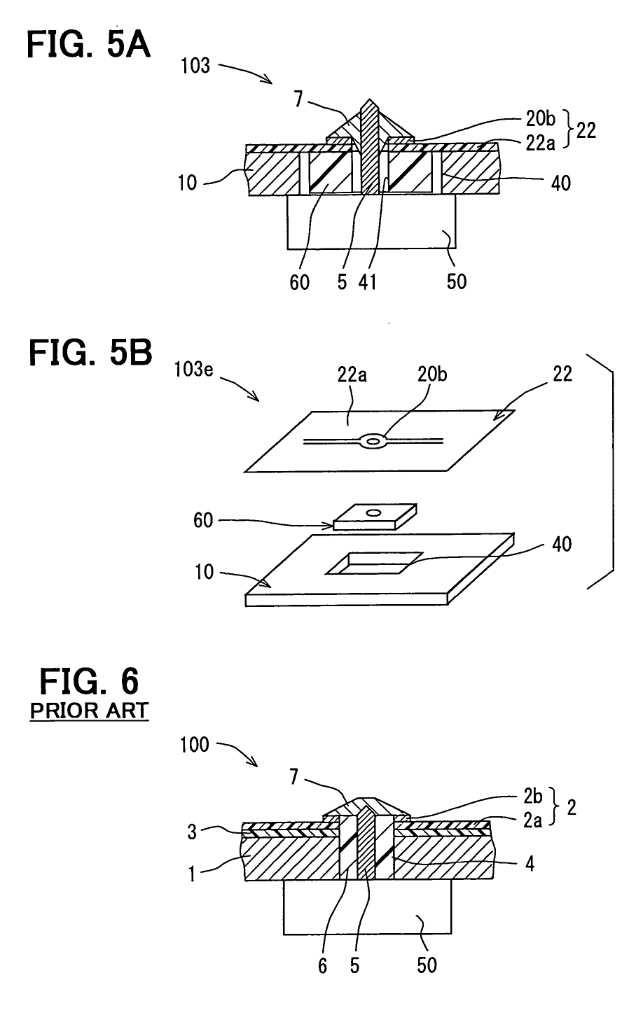

In a circuit board 103 shown in FIG. 5A and FIG. 5B, a printed circuit 22 composed of a thermoplastic resin film 22a and a metal foil circuit pattern 20b on a resin film is used. The thermoplastic resin film 22a is made of, for example, heat-resistant thermoplastic resin typically known as, for example, polyether ether ketone (PEEK), or liquid crystal polymer (LCP).

As shown in FIGS. 5A and 5B, the circuit board 103 with the printed circuit 22 manufactured from the thermoplastic resin film 22a, does not require an adhesive layer to attach the metal plate 10, since the metal plate 10 can be attached directly to the circuit board 103 by heating the thermoplastic resin film 22a in the manufacturing process. Furthermore, the insulating piece 60 which is inserted in the opening 40 on the metal plate 10, can directly be attached to the thermoplastic resin film 22a. Accordingly the insulating piece 60 can be settled, and manufacturing and handling process do not loosen the insulating piece 60.

The circuit board 103 shown in FIG. 5A can be manufactured in the same process explained in FIG. 3 and FIG. 4, without using the adhesive sheet 3. The heat-pressurizing process in FIG. 3E directly attach the circuit board 103 to the metal plate 10 by a press, wherein the thermoplastic resin film 22a is heated to the temperature in the range over the glass-transition point and under the melting point.

Furthermore, in the circuit board 103 made of the thermoplastic resin film 22a shown in FIG. 5A, the lead wire 5 of the electronic component 50 mounted on the metal plate 10 can securely be insulated from the metal plate 10, as the circuit board 101 in FIG. 1A can. Breakups in the proximity of the connecting part of the printed circuit 22 and the lead wire 5 are suppressed likewise, yielding inexpensive circuit boards.

The circuit board 103 made of the thermoplastic resin film 22a shown in FIG. 5A is also suitable for automotive meter panels.

Although the printed circuit 20 in FIG. 1A and the printed circuit 22 in FIG. 5A are single-layered printed circuits, it is possible that the circuit boards according to the present invention use multi-layered printed circuits.

What is claimed is:

1. A circuit board comprising a metal plate as a base, a printed circuit attached to one side of the metal plate and an electronic component mounted on the other side of the metal plate, wherein:
the metal plate has an opening;
an insulating piece of similar thickness as the metal plate is inserted into the opening;
the insulating piece has a first through-hole;
the printed circuit is placed at a bottom of the opening;
the printed circuit has a second through-hole; and
a lead wire of the electronic component is extended in both of the first and the second through-holes and connected to the circuit pattern of the printed circuit by using a conductive metal.

2. A circuit board according to claim 1, wherein:
the electronic component has plural lead wires, and the first and the second through-holes are formed in correspondence with the plural lead wires.

3. A circuit board according to claim 1, wherein:
the printed circuit comprises a thermosetting resin film and a circuit pattern of metal foil formed on the resin film; and the printed circuit is attached to the metal plate by an adhesive layer formed on the other side of the circuit pattern.

4. A circuit board according to claim 1, wherein:
the printed circuit is composed of a thermosetting resin film and the circuit pattern of metal foil formed on the resin film.

5. A circuit board according to claim 1, wherein:
the circuit board is used as an automotive meter panel and the electronic component is one of a connector, a motor, or a buzzer.

6. A manufacturing method of a circuit board that has a metal plate as a base, a printed circuit attached on one side of the metal plate and an electronic component mounted on the other side of the metal plate, the method comprising the steps of:
preparing the metal plate with a certain opening;
preparing an insulating piece of similar thickness as the metal plate and of size insertable in the opening of the metal plate;
preparing the printed circuit of a certain circuit pattern on a resin film;
inserting the insulating piece into the opening, and layering the printed circuit onto the metal plate with the insulating piece inserted therein;
heat-pressurizing the metal plate, the insulating piece, and the printed circuit together by a heat-pressurizing board thereby to attach the metal plate and the insulating piece to the printed circuit; and
connecting a lead wire of the electronic component to a circuit pattern of the printed circuit through a through-hole of the insulating piece and the printed circuit by using a conductive metal.

7. A manufacturing method of a circuit board according to claim 6, wherein:
the through-hole that passes through the insulating piece and the printed circuit is formed after the step of heat-pressurizing.

8. A manufacturing method of a circuit board according to claim 6, wherein:
the through-hole in the insulating piece is formed in the step of preparing the insulating piece, and the through-hole in the printed circuit is formed in the step of preparing the printed circuit.

9. A circuit board comprising a metal plate as a base, an adhesive layer attached to one side of the metal plate, a printed circuit attached to the metal plate by the adhesive layer and an electronic component mounted on the other side of the metal plate, wherein:
the metal plate has an opening;
an insulating piece of the similar thickness as the metal plate is inserted into the opening;
the insulating piece has a first through-hole;
the printed circuit is placed at a bottom of the opening;
the printed circuit has a second through-hole,
the adhesive layer has a third through-hole,
a lead wire of the electronic component is extended in all of the first, the second and the third through-holes and connected to the circuit pattern of the printed circuit by a conductive metal.

10. A manufacturing method of a circuit board that has a metal plate as a base, a printed circuit attached on one side of the metal plate and an electronic component mounted on the other side of the metal plate, the method comprising the steps of:
preparing the metal plate with a certain opening;
preparing an insulating piece of similar thickness as the metal plate and of size insertable in the opening of the metal plate;
preparing the printed circuit of a certain circuit pattern on a resin film;
preparing an adhesive layer for the printed circuit to be attached to the metal plate;
inserting the insulating piece into the opening, and layering the printed circuit with assistance of the adhesive layer onto the metal plate with the insulating piece inserted therein;
heat-pressurizing the metal plate, the insulating piece, the adhesive layer and the printed circuit together by a heat-pressurizing board thereby to attach the metal plate and the insulating piece with the assistance of the adhesive layer to the printed circuit; and
connecting a lead wire of the electronic component to a circuit pattern of the printed circuit through a through-hole of the insulating piece, the adhesive layer and the printed circuit by using a conductive metal.

11. A manufacturing method of a circuit board according to claim 10, wherein:
the through-hole that passes through the insulating piece, the adhesive layer and the printed circuit is formed after the step of heat-pressurizing.

12. A manufacturing method of a circuit board according to claim 10, wherein:
the through-hole in the insulating piece is formed in the step of the preparing the insulating piece, the through-hole in the adhesive layer is formed in the step of preparing the adhesive layer, and the through-hole in the printed circuit is formed in the step of preparing the printed circuit.
